(19) United States
(12) Patent Application Publication
(10) Pub. No.: US 2008/0217971 A1
(43) Pub. Date: Sep. 11, 2008

(54) Active Head Restraint

(76) Inventor: Zbigniew A. Paluch, Northville, MI (US)

Correspondence Address: MAGNA INTERNATIONAL, INC., 337 MAGNA DRIVE, AURORA, ON, L4G-7K1, CA

(21) Appl. No.: 12/091,188

(22) PCT Filed: Oct. 24, 2006
(86) PCT No.: PCT/CA06/01745

§ 371 Date: Apr. 23, 2008

(51) Int. Cl. B60N 2/427; B60N 2/48

(52) U.S. Cl. 297/216.12

(57) ABSTRACT

A seat assembly for supporting a seat occupant in an automotive vehicle includes a seat cushion and a seat back. The seat back includes a seat back frame having an upper cross member. A head restraint assembly is pivotally and slidably coupled to the seat back frame. The head restraint assembly includes a head restraint that is movable between an operational position and a deployed position, which is forward and upward relative to the seat back. An activation assembly is pivotally coupled to the upper cross member and is operatively coupled to the head restraint assembly such that the head restraint assembly moves from the operational position to the deployed position in response to rearward loading of the activation assembly by the seat occupant.

### FIELD OF THE INVENTION

The invention relates to a seat assembly for an automotive vehicle. More particularly, the invention relates to an active head restraint that moves upwardly and forwardly relative to the seat assembly to engage a head of a seat occupant in response to an impact to the vehicle.

### BACKGROUND OF THE INVENTION

A typical seat assembly for an automotive vehicle includes a generally horizontal seat cushion for supporting a seat occupant and a generally upright seat back. The seat back is commonly pivotally coupled to the seat cushion via a recliner mechanism for providing selective angular adjustment of the seat back relative to the seat cushion between a plurality of reclined seating positions. Typically, a head restraint extends vertically above the seat back to restrict movement of a head of the seat occupant during an automotive vehicle impact, particularly during a rear impact collision.

Various head restraints have been developed that move upwardly and forwardly relative to the seat back to engage the head of the seat occupant in response to an impact of the seat occupant against the seat back. These movable head restraints are well known to those skilled in the art. It remains desirable, however, to provide an activation assembly for automatically and continuously positioning the head restraint with the head of the seat occupant in response to an impact of the seat occupant against the seat back.

### SUMMARY OF THE INVENTION

According to one aspect of the invention, a seat assembly for supporting a seat occupant in an automotive vehicle includes a seat cushion and a seat back. The seat back includes a seat back frame having an upper cross member. A head restraint assembly is pivotally and slidably coupled to the seat back frame. The head restraint assembly includes a head restraint that is movable between an operational position and a deployed position, which is forward and upward relative to the seat back. An activation assembly is pivotally coupled to the upper cross member and is operatively coupled to the head restraint assembly such that the head restraint assembly moves from the operational position to the deployed position in response to rearward loading of the activation assembly by the seat occupant.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a front perspective view of a seat assembly including an active head restraint according to the invention;

FIG. 2 is a fragmentary, front perspective view of a seat back including the head restraint in an operational position and an activation assembly in an initial position;

FIG. 3 is a fragmentary, rear perspective view of the seat back including the head restraint in the operational position and the activation assembly in the initial position;

FIG. 4 is a fragmentary, front perspective view of the head restraint in a deployed position and the activation assembly in an activated position;

FIG. 5 is a fragmentary, rear perspective view of the head restraint in the deployed position and the activation assembly in the activated position;

FIG. 6 is a fragmentary, front perspective view of the seat back including a second embodiment of the invention having a preformed control bar;

FIG. 7 is a fragmentary, rear perspective view of the seat back including the second embodiment of the invention having the preformed control bar; and

FIG. 8 is a front perspective view of the seat back including a third embodiment of the invention having a pair of coil springs for biasing the head restraint to the operational position; and

FIG. 9 is a front perspective view of the seat back according to a fourth embodiment of the invention including an activation link having an integrally formed flange defining an open slot.

### DETAILED DESCRIPTION OF THE PREFERRED EMBODIMENTS

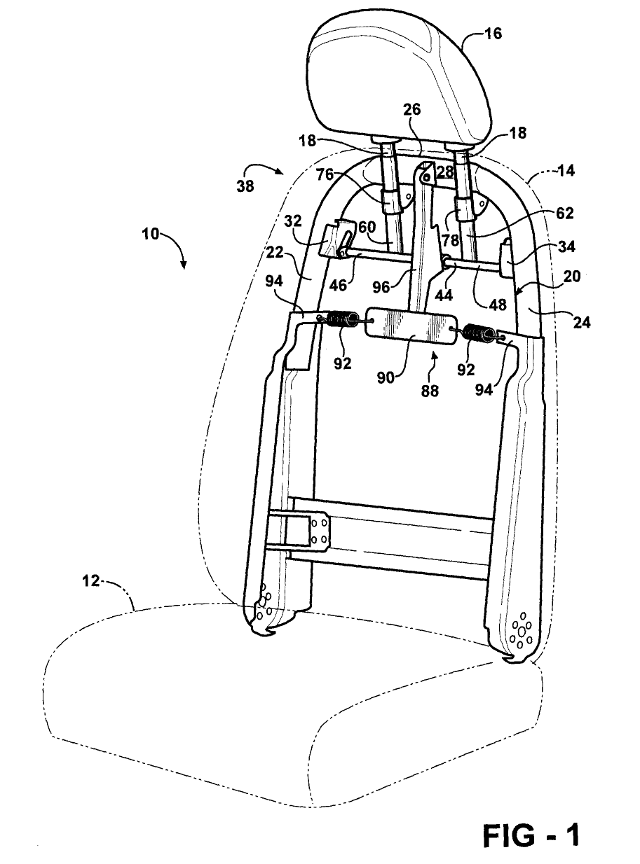

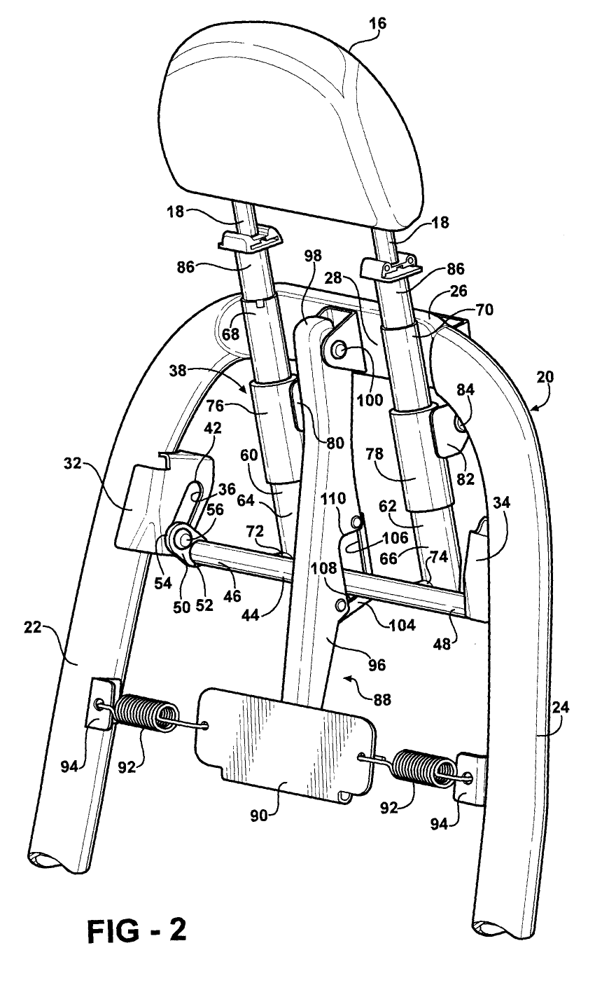

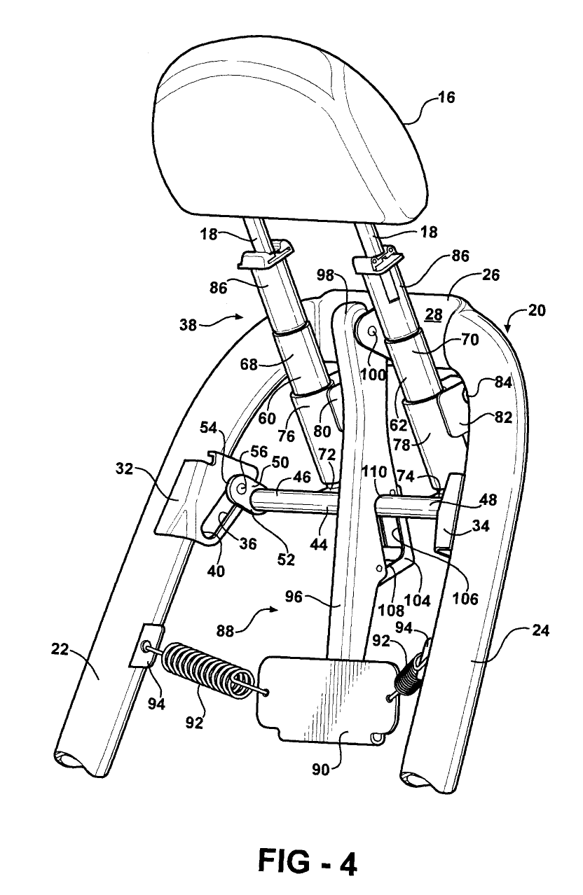

Referring to FIG. 1, a seat assembly for an automotive vehicle is generally shown at 10. The seat assembly 10 includes a generally horizontal seat cushion 12 for supporting a seat occupant above a floor in the vehicle. The seat assembly 10 also includes a generally upright seat back 14 pivotally coupled to the seat cushion 12 by a recliner mechanism for providing selective angular adjustment of the seat back 14 between a plurality of reclined seating positions. The seat assembly 10 further includes a head restraint 16. The head restraint 16 is adjustably attached to the seat back 14 via a pair of spaced apart and parallel armatures 18. The armatures 18 are operatively coupled to a seat back frame, generally indicated at 20, within the seat back 14 for providing vertical adjustment of the head restraint 16 relative to the seat back 14. Additionally, the head restraint 16 is automatically movable between an operational position generally parallel with the seat back 14, as shown in FIGS. 1 and 2, and a deployed position forward and upward relative to the seat back 14, as shown in FIG. 4.

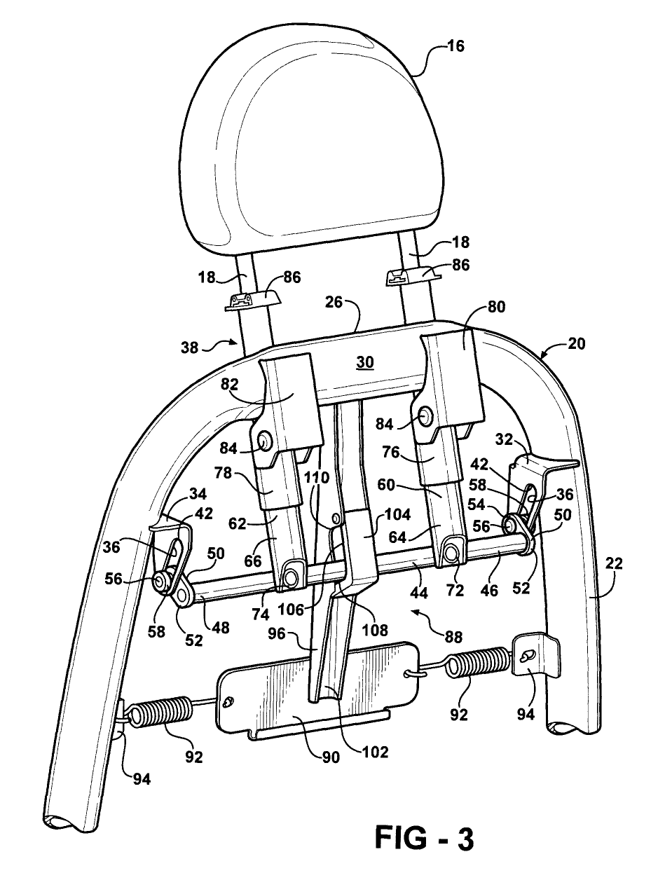

Referring to FIGS. 2 and 3, the seat back frame 20 includes a pair of spaced apart side members 22, 24 and an upper cross member 26 extending between the side members 22, 24. The side members 22, 24 are generally parallel and define a vertical plane therebetween. The upper cross member 26 defines a front side 28 and a back side 30.

Referring to FIGS. 2 through 5, a first guide bracket 32 and a second guide bracket 34 are fixedly secured to the side members 22, 24, respectively. Each of the first 32 and second 34 guide brackets includes a guide slot 36 for guiding or otherwise controlling movement of a head restraint assembly, generally shown at 38. In the embodiment shown, the guide slot 36 is generally linear and extends between a first end 40 and a second end 42.

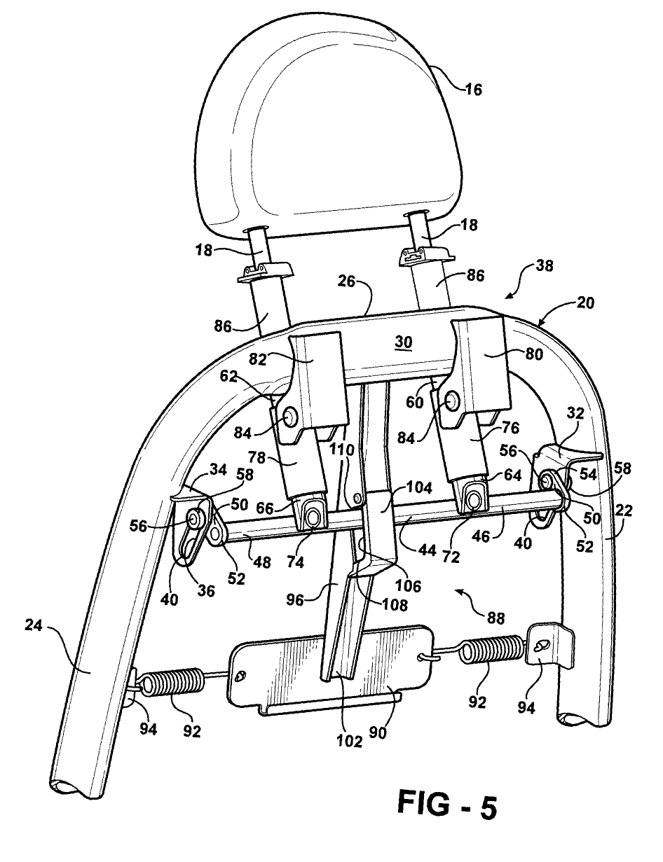

The head restraint assembly 38 includes a horizontal control bar 44 having first 46 and second 48 ends extending between the side members 22, 24. An arm link 50 is disposed at each of the first 46 and second 48 ends, extending perpendicular to the control bar 44. Each arm link 50 has a proximal end 52 fixedly secured to one of the first 46 or second 48 ends of the control bar 44 and an opposite distal end 54. A guide pin 56 having an elongated cylindrical body extends laterally from the distal end 54 of each arm link 50. The guide pins 56 are pivotally and slidably coupled within the guide slots 36 such that each guide pin 56 is moveable within the respective guide slot 36 from the first end 40, as shown in FIGS. 2 and 3, to the second end 42, as shown in FIGS. 4 and 5. Each guide pin 56 includes a radially extending flange 58 at the end for controlling transverse movement of the control bar 44.

The head restraint assembly 38 also includes a pair of spaced apart vertical posts 60, 62 extending perpendicular to the horizontal control bar 44, between lower ends 64, 66 and upper ends 68, 70. The lower ends 64, 66 of the posts 60, 62 are fixedly secured to the control bar 44 by connecting tubes 72, 74 extending between the posts 60, 62 and the control bar 44. The upper ends 68, 70 of the posts 60, 62 are disposed adjacent the front side 28 of the upper cross member 26.

Referring to FIGS. 2 and 3, a pair of spaced apart guide tubes 76, 78 is pivotally coupled to a pair of guide tube brackets 80, 82 by pivots 84. The guide tube brackets 80, 82 are fixedly secured to the back side 30 of the upper cross member 26. Each guide tube 76, 78 has an axial bore for receiving one of the posts 60, 62 therethrough. The posts 60, 62 are slidably moveable within the axial bore of the guide tubes 76, 78. The pivots 84 between the guide tubes 76, 78 and the guide tube brackets 80, 82 allow the posts 60, 62 and therefore the head restraint assembly 38 to pivot relative to the seat back frame 20.

Head restraint sleeves 86 having an axial bore are inserted into the upper ends 68, 70 of the posts 60, 62 for receiving the head restraint armatures 18 therethrough. The head restraint sleeves 86 are well known to one skilled in the art. The armatures 18 are slidable relative to the head restraint sleeves 86 allowing the seat occupant to vertically adjust the head restraint 16 to a desired position.

An activation assembly, generally shown at 88, includes an impact plate 90 disposed an equal distance between the side members 22, 24. The impact plate 90 pivots between an initial position generally co-planar with the vertical plane defined by the side members 22, 24, as shown in FIG. 2, in which the head restraint 16 is in the operational position, and an activated position generally rearward of the vertical plane defined by the side members 22, 24, as shown in FIG. 4, in which the head restraint 16 is in the deployed position. The impact plate 90 is biased to the initial position by a pair of biasing springs 92. More specifically, an attachment tab 94 is fixedly secured to each of the side members 22, 24 and each biasing spring 92 extends between one of the attachment tabs 94 and the impact plate 90.

The activation assembly 88 also includes an activation link 96 extending between a proximal end 98 pivotally coupled by an upper pivot 100 to the front side 28 of the upper cross member 26 and an opposite distal end 102 fixedly secured to the impact plate 90. The activation link 96 pivots about the upper pivot 100 in response to a rearward impact against the impact plate 90.

A generally L-shaped control bar guide 104 fixedly secured to the activation link 96 between the proximal 98 and distal 102 ends defines a slot 106 in the activation link 96. In the embodiment shown, the control bar guide 104 is formed from a plastic material but it is recognized that the control bar guide 104 could be made from any suitable material without varying the scope of the invention. The slot 106 extends between a first end 108 and a second end 110. The control bar 44 extends through the slot 106 resulting in the activation assembly 88 being operatively coupled to the head restraint assembly 38. The control bar 44 is pivotally and slidably moveable within the slot 106.

In operation, starting with the head restraint 16 in the operational position, when the vehicle is impacted, such as during a rear crash event, the back of the seat occupant presses against or rearwardly loads the impact plate 90 within the seat back 14. Rearward loading of the impact plate 90 causes the head restraint 16 to move upwardly and forwardly relative to the seat back 14 to the deployed position thereby minimizing the distance between the head of the seat occupant and the head restraint 16 to help prevent whiplash. More specifically, rearward loading of the impact plate 90 from the initial position to the activated position causes the activation link 96 to pivot rearwardly about the upper pivot 100. As the activation link 96 pivots rearwardly, the control bar guide 104 urges the control bar 44 to move upwardly and rearwardly, sliding and pivoting within the slot 106 from the first end 108 to the second end 110. At the same time the guide pins 56 slide and pivot along the guide slots 36 from the first ends 40 to the second ends 42. As the control bar 44 moves upwardly and rearwardly the lower ends 64, 66 of the posts 60, 62 also move upwardly and rearwardly which causes the guide tubes 76, 78 to pivot forwardly about pivots 84. The forward pivoting of the guide tubes 76, 78 cause the upper ends 68, 70 of the posts 60, 62 to pivot forwardly, thereby driving the armatures 18 and thus the head restraint 16 upwardly and forwardly so as to provide support to the head of the seat occupant.

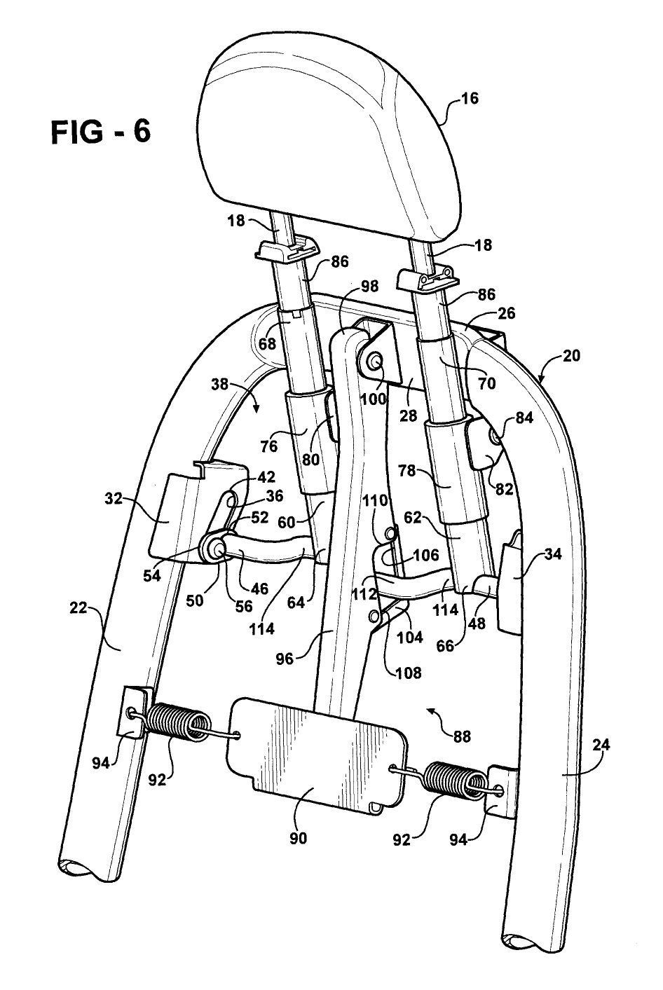

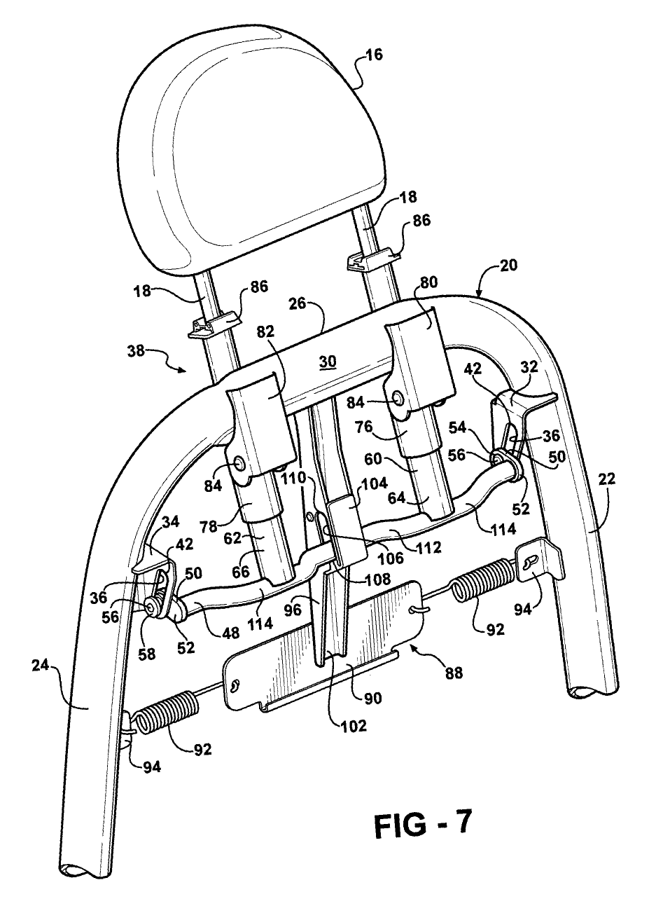

Referring to FIGS. 6 and 7, in a second embodiment of the invention, the head restraint assembly 38 includes a preformed control bar 112. The control bar 112 includes two arcuate segments 114. The arcuate segments 114 allow the lower ends 64, 66 of the posts 60, 62 to be fixedly secured directly to the control bar 44 eliminating the need for the connecting tubes 72, 74.

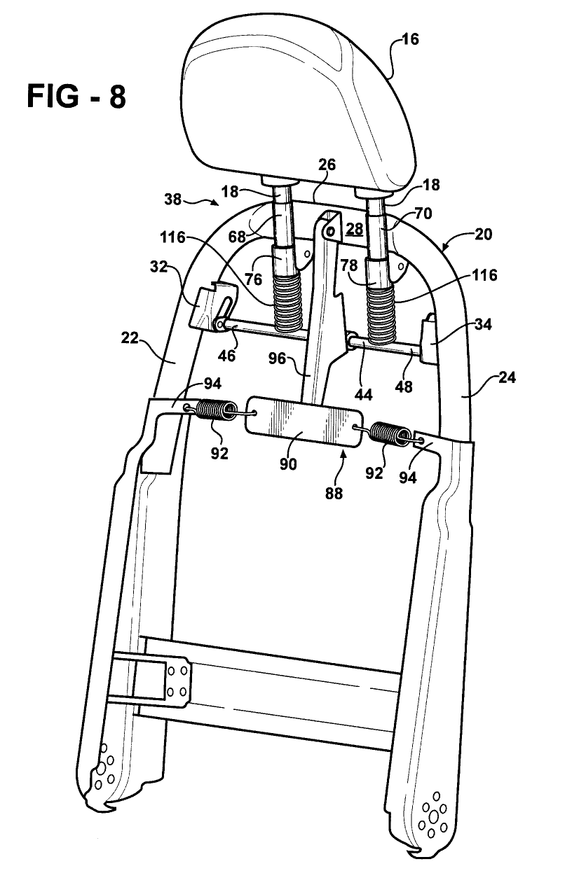

Referring to FIG. 8, in a third embodiment of the invention, a coil spring 116 is disposed around the lower end 64, 66 of each of the posts 60, 62 between the guide tubes 76, 78 and the control bar 44. The coil springs 116 help bias the impact plate 90 to the initial position and the head restraint 16 to the operational position.

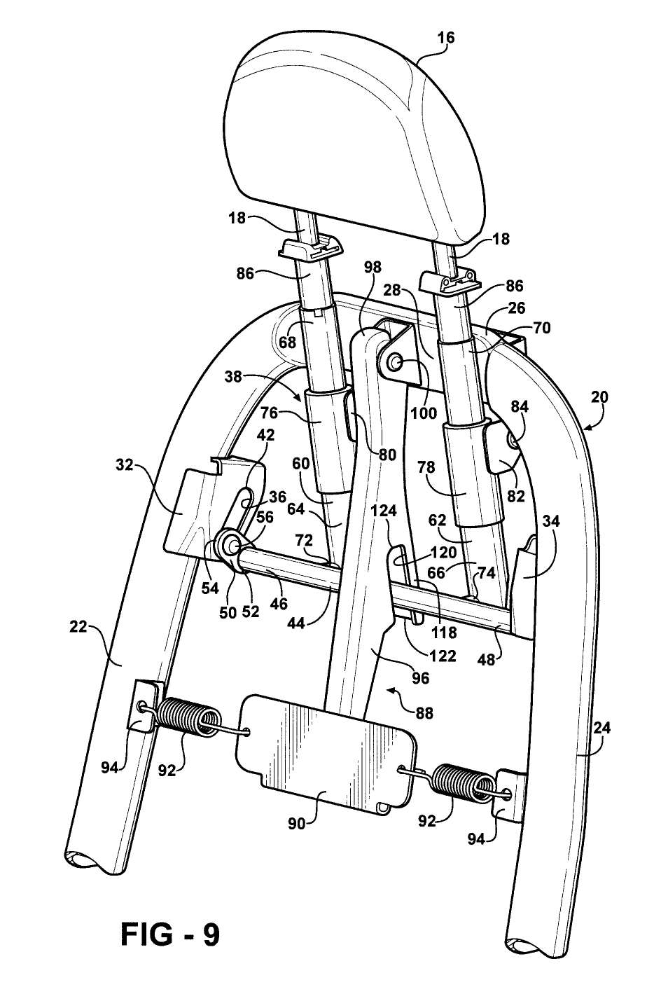

Referring to FIG. 9, in a fourth embodiment of the invention, the separate control bar guide 104 fixedly secured to the activation link 96 is replaced by a flange 118 integrally formed with the activation link 96 between the proximal 98 and distal 102 ends. The flange 118 defines an open slot 120 extending between a first open end 122 and a second closed end 124.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed:

1. A seat assembly for an automotive vehicle including a seat cushion and a seat back for supporting a seat occupant, said seat assembly comprising:
a seat back frame having an upper cross member;
a head restraint assembly pivotally and slidably coupled to said seat back frame, said head restraint assembly including a head restraint movable between an operational position and a deployed position forward and upward relative to the seat back; and
an activation assembly pivotally coupled to said upper cross member and operatively coupled to said head restraint assembly such that said head restraint moves from said operational position to said deployed position in response to rearward loading of said activation assembly by the seat occupant.

2. A seat assembly as set forth in claim 1 including a pair of guide tubes having axial bores for slidably guiding said head restraint assembly, each of said pair of guide tubes pivotally coupled to said upper cross member for allowing pivotal movement of said head restraint assembly relative to said seat back frame.

3. A seat assembly as set forth in claim 2 wherein said head restraint assembly includes a horizontal control bar extending between first and second ends pivotally and slidably coupled to said seat back frame, and a pair of spaced apart vertical posts extending between lower ends fixedly secured to said control bar and upper ends for supporting said head restraint, said pair of spaced apart vertical posts extending through said axial bores of said pair of guide tubes.

4. A seat assembly as set forth in claim 3 wherein said activation assembly includes an activation link extending between a proximal end pivotally coupled to said upper cross member and a distal end having an impact plate fixedly secured thereto.

5. A seat assembly as set forth in claim 4 wherein said impact plate pivots between an initial, forward position and an activated, rearward position in response to said rearward loading.

6. A seat assembly as set forth in claim 5 wherein said activation link includes a slot formed therein between said proximal end and said distal end, said control bar extending through said slot operatively coupling said activation assembly and said head restraint assembly.

7. A seat assembly as set forth in claim 6 including at least one biasing spring extending between said impact plate and said seat back frame for biasing said impact plate to said initial position.

8. A seat assembly as set forth in claim 7 including a head restraint sleeve having an axial bore inserted into each of said upper ends of said pair of spaced apart vertical posts for slidably receiving a pair of armatures extending from said head restraint to provide selective vertical adjustment of said head restraint.

9. A seat assembly as set forth in claim 8 wherein said head restraint assembly includes a coil spring disposed about each of said pair of spaced apart vertical posts between said pair of guide tubes and said horizontal control bar for biasing said impact plate to said initial position and said head restraint to said operational position.
